(19) United States
(12) Patent Application Publication
(10) Pub. No.: US 2008/0152314 A1
(43) Pub. Date: Jun. 26, 2008

(54) Camera apparatus and reproduction control method in camera apparatus

(75) Inventors: Yoshihide Uchida, Tokyo (JP); Tatsuhiko Ikehata, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/976,581

(22) Filed: Oct. 25, 2007

(30) Foreign Application Priority Data
Dec. 20, 2006 (JP) 2006-343245

(51) Int. Cl. H04N 5/00

(52) U.S. Cl. 386/117

(57) ABSTRACT

According to one embodiment, a camera apparatus includes a reproduction control unit reproducing a shot video after a plurality of index images using “I” frames extracted at predetermined intervals from moving image data for reproducing the shot video are generated and displayed, when reproducing the shot video.

### CROSS-REFERENCE TO RELATED APPLICATIONS

This application is based upon and claims the benefit of priority from Japanese Patent Application No. 2006-343245, filed Dec. 20, 2006, the entire contents of which are incorporated herein by reference.

### BACKGROUND

1. Field

One embodiment of the invention relates to a camera apparatus generating an index image from moving image data indicating a shot video, such as a digital camera, a video camera or so forth, and a reproduction control method in the camera apparatus.

2. Description of the Related Art

Conventionally, there is known a camera apparatus (also called an electronic camera apparatus) importing an optical image of a subject as a still image or a moving image, converting the shot image into image data and electronically save it.

Conventional camera apparatuses include a digital camera mainly shooting the still image and a video camera mainly shooting the moving image.

Conventionally, a variety of the digital cameras and video cameras are widely spread. For instance, in Japanese Patent Application Publication (KOKAI) No. 2001-211421 (Patent document 1), there is disclosed a digital camera generating and recording index images in which reduced images of a plurality of still images extracted from continuous images are arranged in one screen.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing main components of a camera apparatus according to an embodiment of the invention;

FIG. 2 is an exemplary view showing data structure of moving image data compressed by a compression/decompression processing unit in compliance with MPEG-2 in the embodiment;

FIG. 3 is an exemplary view showing the data structure of the moving image data compressed by the compression/decompression processing unit in compliance with MPEG-2 in the same manner as in FIG. 2 by showing GOPs as well as index image generating points in the embodiment;

FIG. 4 is an exemplary view showing an example of pictures constituting a GOP in the embodiment;

FIG. 5 is an exemplary view showing an example of a reproduction menu in the embodiment; and

FIG. 6 is an exemplary flowchart showing a procedure of a reproduction control operation of a video in the embodiment.

### DETAILED DESCRIPTION

Various embodiments according to the invention will be described hereinafter with reference to the accompanying drawings. In general, according to one embodiment of the invention, a camera apparatus includes a reproduction control unit reproducing a shot video after a plurality of index images using “I” frames extracted at predetermined intervals from moving image data for reproducing the shot video are generated and displayed, when reproducing the shot video.

A camera apparatus has: a reproduction device reproducing a shot video; an extraction unit extracting “I” frames at predetermined intervals from moving image data necessary for the reproduction device to reproduce the shot video; an index image generating unit generating a plurality of index images using the “I” frames extracted by the extraction unit; and a reproduction control unit reproducing the shot video after the index images generated by the index image generating unit are displayed, when the reproduction device reproduces the shot video.

A reproduction control method in a camera apparatus provided with a reproduction device for reproducing a shot video is conducted in such a manner. That is, the shot video is reproduced after a plurality of index images using “I” frames extracted at predetermined intervals from moving image data for reproducing the shot video are generated and displayed, when the reproduction device reproduces the shot video.

(Components of Camera Apparatus)

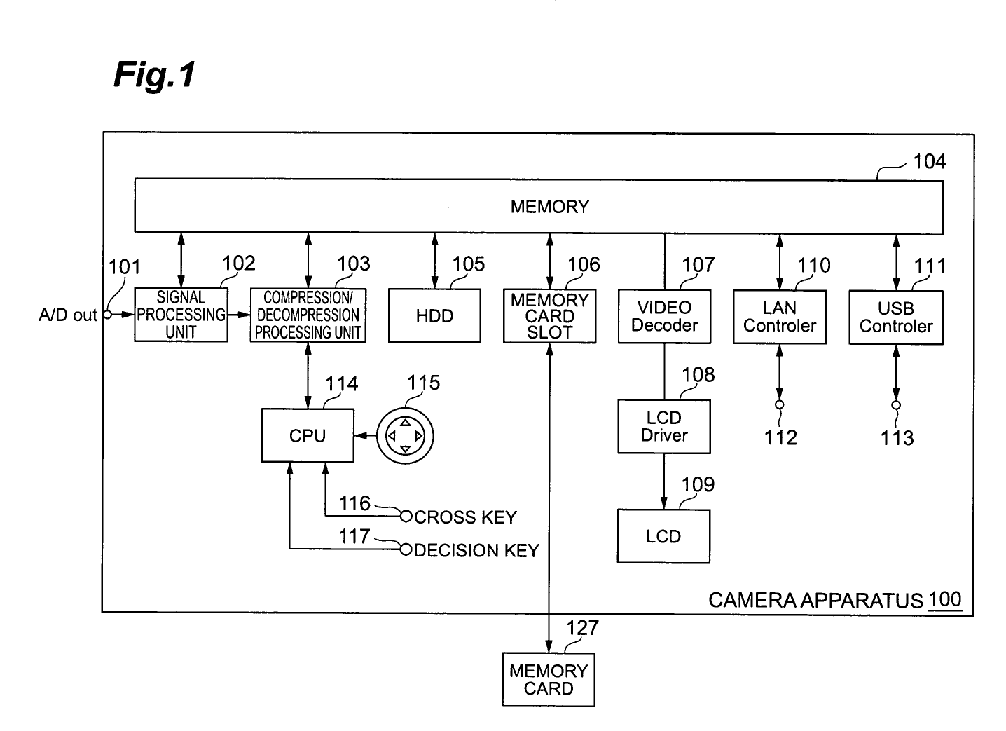

FIG. 1 is a block diagram showing main components of a camera apparatus 100 according to an embodiment of the invention. The camera apparatus 100 shown in FIG. 1 is a digital video camera apparatus shooting mainly a moving image and also capable of shooting a still image.

Further, the camera apparatus 100 deals with data compressed in compliance with MPEG-2 when shooting or reproducing the moving image data. When reproducing the moving image data, the camera apparatus 100 can easily realize a trick reproduction such as a reverse reproduction, a high-speed reproduction, a high-speed reverse reproduction, a flame forward and a flame rewind, other than a normal reproduction. Furthermore, as a recording medium of the image data, the camera apparatus 100 uses, not a magnetic tape, but a random-access capable recording medium such as a later-described HDD 105 and a memory card 127. Therefore, a search of a desired video can be easily conducted.

The camera apparatus 100 includes a digital signal output unit 101, a signal processing unit 102, a compression/decompression processing unit 103, a memory 104 and a HDD (Hard Disk Drive) 105.

Further, the camera apparatus 100 includes a memory card slot 106, a video decoder 107, an LCD (Liquid Crystal Display) driver 108, an LCD 109, a LAN controller 110 and a USB controller 111. Furthermore, the camera apparatus 100 includes a LAN terminal 112, a USB terminal 113, a CPU 114, an operation unit 115, a cross key 116 and a decision key 117.

The digital signal output unit 101 converts an analog electric signal, which is generated by a CCD (Charge Coupled Device) using an optical image of a subject obtained through a not-shown lens, into a digital signal to output it to the signal processing unit 102.

The signal processing unit 102 has a function as a moving image data generating device which performs an image processing to the inputted digital signal to thereby generate moving image data indicating a shot video actually shot. Note that the generated moving image data is once stored in the memory 104.

The compression/decompression processing unit 103 compresses the moving image data exported from the memory 104 in compliance with MPEG-2 to thereby produce compressed moving image data, or compresses still image data in compliance with JPEG to produce compressed still image data. Further, in accordance with an instruction of the CPU 114, the compression/decompression processing unit 103 decompresses the compressed moving image data and the compressed still image data.

The memory 104 temporarily memorizes data to be a processing target of the signal processing unit 102, data to be a processing target of the compression/decompression processing unit 103, and a later-described extracted “I” picture 312I.

The HDD 105 is an external memory apparatus recording the compressed moving image data, the sound data and the compressed still image data in a HD (Hard Disc) built therein. The HDD 105 reads/writes data with respect to the HD (Hard Disc) based on a random access.

A memory card 127 such as an SD memory card (Secure Digital memory card) is inserted into the memory card slot 106, and the memory card slot 106 reads/writes data with respect to the memory card 127 inserted thereinto. The compressed moving image data and the like are recorded in the memory card 127.

In order to display the shot video using the compressed moving image data, the video decoder 107 performs a decoding process to the moving image data to thereby output it to the LCD driver 108. The video decoder 107 is a software decoder realized by a decoding program.

The LCD driver 108 converts the decoded moving image data received from the video decoder 107 into a display signal compatible with an interface of the LCD 109. The LCD 109 displays the shot video using the display signal outputted from the LCD driver 108.

The video decoder 107 performs a decoding process to the moving image data, the LCD driver 108 converts the decoded moving image data, and the LCD 109 displays the shot video. By this, the shot video is reproduced. In this case, the video decoder 107, the LCD driver 108 and the LCD 109 compose a reproduction device.

In accordance with the instruction of the CPU 114, the LAN controller 110 transfers the moving image data obtained from the memory 104 to a not-shown external apparatus (for example, a DVD recoder or an HDD recorder) connected via the LAN terminal 112. Besides, the LAN controller 110 outputs the moving image data imported from the external apparatus via the LAN terminal 112 to the memory 104.

In accordance with the instruction of the CPU 114, the USB controller 111 transfers the moving image data obtained from the memory 104 to a not-shown external apparatus (for example, a personal computer) connected via the USB terminal 113. Besides, the USB controller 111 outputs the moving image data imported from the external apparatus via the USB terminal 113 to the memory 104.

In accordance with a program memorized in a not-shown ROM, the CPU 114 operates as various units (an extraction unit, an index image generating unit, a reproduction control unit, a detection unit) being a feature of the embodiment. Further, the CPU 114 inputs/outputs a signal into/from the other components to control the entire operation or the respective sequences of the camera apparatus 100.

The operation unit 115 includes a JOG dial. The operation unit 115 is an operation device in which a user selects and performs various functions (for example, start of the reproduction, start of the shooting, stop of the reproduction, stop of the shooting, and so forth) in the camera apparatus 100.

Further, if the JOG dial is operated while the moving image is being reproduced, a reproduction speed is adjusted in accordance with the operation. The user can select a video to be reproduced with the cross key 116 and decide the video with the decision key 117.

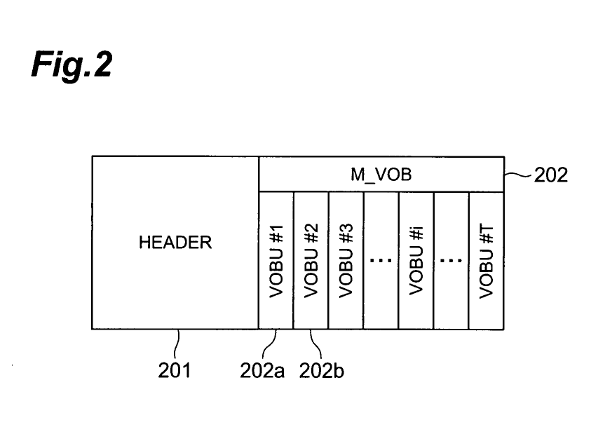

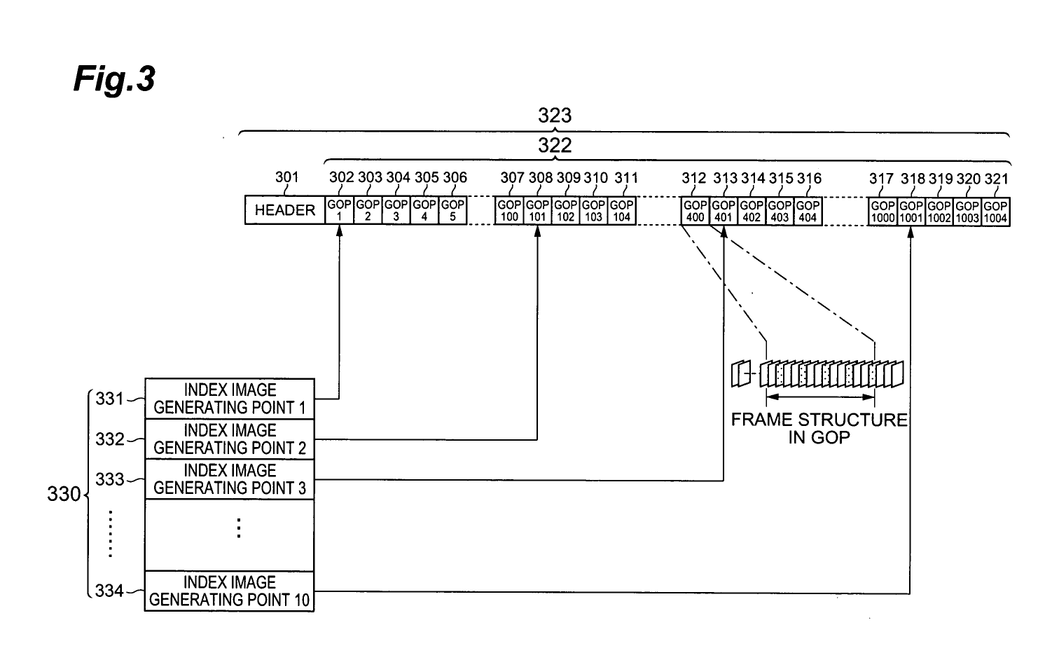

Subsequently, the data structure of the moving image data compressed in compliance with MPEG-2 by the compression/decompression processing unit 103 will be described with reference to FIG. 2 and FIG. 3. Here, FIG. 2 is a view showing the data structure of the moving image data compressed in compliance with MPEG-2 by the compression/decompression processing unit 103.

The moving image data includes a header section 201 and a data section 202. In the header section 201, there is a VOBU-ENT information section which records each size of respective VOBUs (Video Object Block Unit) composing the data section 202. In the data section 202, a plurality of the VOBUs (VOBU 202a, 202b, etc.) are provided.

The number of the VOBUs is proportional to the shooting time. One VOBU has the moving image data for 0.5 seconds compressed in compliance with MPEG-2, that is, a later-described one GOP (Group of Pictures) and a lot of header information. For example, when shooting for 10 minutes, 1200 GOPs are generated, determined by 10 minutes×60 seconds/0.5. Since the size of each VOBU is recorded in the VOBU-ENT information section of the header section 201, the size information of each 1200 GOPs is recorded therein.

Further, similarly, FIG. 3 is a view showing the structure of moving image data 323 compressed in compliance with MPEG-2 by the compression/decompression processing unit 103 by showing GOPs as well as an index image generating point 330. When reproducing the shot video using the moving image data 323, in the camera apparatus 100, it is possible to combine a certain unit of the moving image or a certain pieces of the moving images into the GOP, and reproduce separately for each unit of the GOP. The GOP includes the moving image data corresponding to fifteen flames.

The moving image data 323 includes a header 301 and a moving image stream 322 indicating a shot video actually shot.

The header 301 records management information such as initial data necessary for the video decoder 107 to decode the moving image data and reproduce the shot video, such as the size of the image, a pixel aspect ratio and so forth.

The index image generating point 330 includes a plurality of index image generating points 331, 332, 333, 334. Each of the index image generating points 331, 332, 333, 334 identifies a GOP to be a generation target of a later-described index image.

As described later, the index images are generated using “I” frames extracted at predetermined intervals from the moving image data 323. Each of the index image generating points 331, 332, 333, 334 indicates a position of a corresponding GOP counting from the head, and corresponds to GOPs 302, 308, 313, 318, respectively. In FIG. 3, the index image generating points 331, 332, 333, 334 correspond to GOPs each having an interval of 100 GOPs, and the GOP 308 indicates an 101st GOP, the GOP 313 indicates a 401st GOP, for example.

The moving image stream 322 is structured as a data stream having a plurality of GOPs (GOPs 302 to 321), each of which being recorded for 0.5 seconds. Each of the GOPs is a unit of an edit process using the operation unit 115, and is a data corresponding to 0.5 seconds of the shooting time.

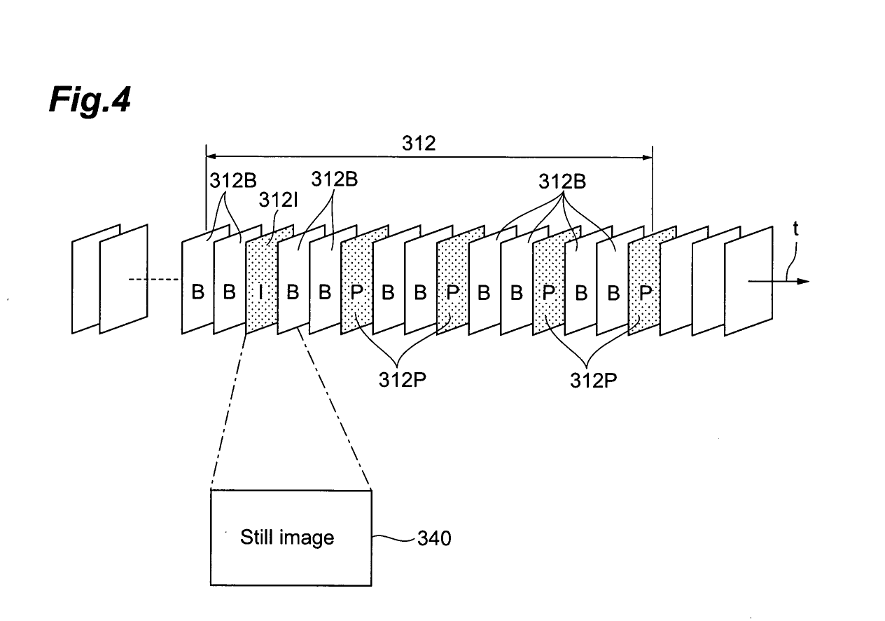

Further, each of the GOPs includes a plurality of pictures (also called as frames) as shown in FIG. 4 in detail (fifteen pictures in this embodiment). FIG. 4 indicates a GOP 312. In each of the GOPs, similar to the GOP 312, there are three kinds of an “I” picture 312I, a “P” picture 312P and a “B” picture 312B, which are arranged along a time axis t as shown in FIG. 4.

The “I” picture 312I is an intra-frame coding image (Intra-Picture), which is a picture to be a basis at a time of compression. The “P” picture 312P is a predictive coding image (Predictive-Picture) and is inter-frame forward predictively coded from the preceding “I” picture 312I. The “B” picture 312B is a bidirectionally predictive coding image (Bidirectionally-predictive-Picture) and is bidirectionally predictively coded from the “P” picture or the “I” picture preceding/succeeding the “B” picture 312B.

Among the three pictures, the “I” picture 312I is encoded in the frame so that it keeps its independence. In other words, the “I” picture 312I can restore one frame by itself without using other pictures. Focusing attention on this point, the embodiment of the invention extracts the “I” picture 312I.

As described later in detail, in the camera apparatus 100, the “I” picture 312I is extracted from the GOP and converted into a still image data to display one Still Image 340. The camera apparatus 100 is designed to generate and display the index image using this still image data (details will be described later).

(Operation Details of Camera Apparatus)

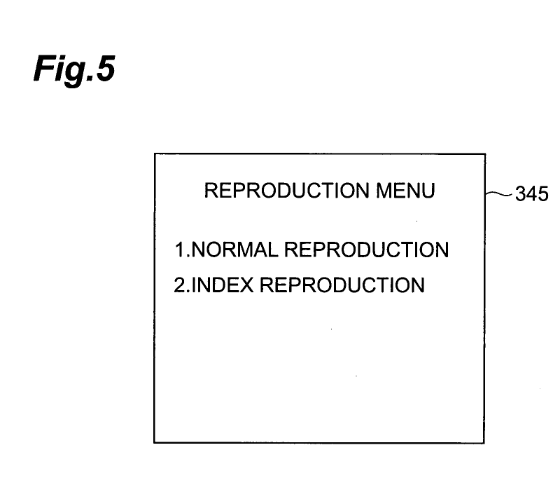

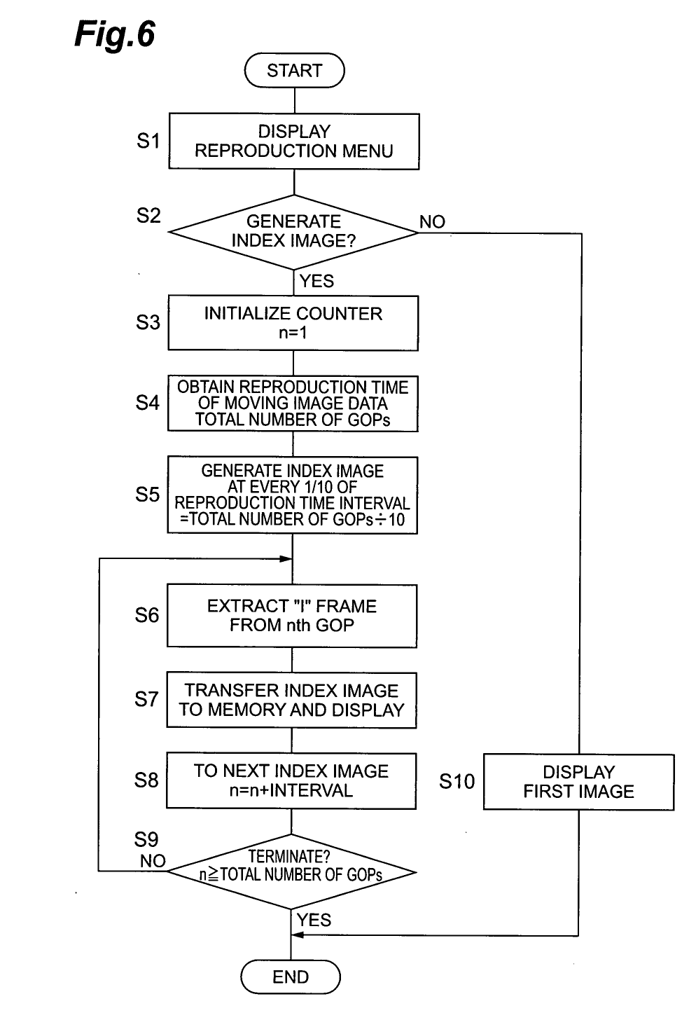

Next, an operation procedure of the reproduction control process of the video by the camera apparatus 100 will be described. FIG. 5 is a view showing an example of a reproduction menu 345 of the video displayed on the LCD 109, and FIG. 6 is a flowchart showing the operation procedure of the reproduction control process of the video. The operation procedure shown in the flowchart of FIG. 6 is executed by the CPU 114.

First, a user operates the operation unit 115 or the cross key 116 to select a video to be reproduced, and decide the video by operating the decision key 117. After that, the user instructs start of the reproduction by operating the operation unit 115. Accordingly, the camera apparatus 100 reproduces the shot video using the corresponding moving image data. In this case, the CPU 114 performs an operation as a reproduction control unit to execute a reproduction control process of a video in accordance with the flowchart shown in FIG. 6.

When the reproduction control process of the video is started, the CPU 114 displays the reproduction menu 345 on the LCD 109 (S1). This reproduction menu 345 includes two items of “1 normal reproduction” and “2 index reproduction”, as shown in FIG. 5. Among the items, the normal reproduction corresponds to a normal reproduction mode reproducing the shot video without displaying the index images, and the index reproduction corresponds to an index reproduction mode reproducing the shot video after displaying the index images. The user can select either mode by operating the operation unit 115 as a mode selection device.

Next, the CPU 114 judges which mode the user selects between the “1 normal reproduction” and the “2 index reproduction”, based on an inputted signal from the operation unit 115 (S2). Here, when the “1 normal reproduction” is selected, the CPU 114 proceeds process to S10, and when the “2 index reproduction” is selected, the CPU 114 proceeds process to S3 to generate the index images.

The CPU 114 initializes a counter n (set “1”) (S3). This counter n indicates the above-described index image generating point.

Subsequently, the CPU 114 obtains a reproduction time of the moving image data to be used for the reproduction and calculates a number of GOPs of whole moving image data (total number of GOPs) based on the obtained reproduction time (S4).

Further, the CPU 114 determines an interval of GOPs (GOP interval) for generating later-described index images (S5). For example, the CPU 114 can set the GOP interval according to the time corresponding to one tenth of the reproduction time (unit reproduction time). In this case, the GOP interval is set at one tenth of the total number of GOPs. For example, as shown in FIG. 3, when the total number of GOPs is 1004, the GOP interval can be set at 100. Accordingly, the index image generating points are set at every GOP interval, such as a first GOP (GOP 302) and a 101st GOP (GOP 308). It should be noted that the GOP interval can be set according to the time corresponding to other than one tenth of the reproduction time.

Next, the CPU 114 detects a GOP corresponding to the counter n and extracts the “I” picture from the detected GOP (nth GOP). In this case, the CPU 114 performs an operation as a detection unit to detect the GOPs at GOP intervals.

Further, after transferring the extracted “I” pictures 312I to the memory 104, the CPU 114 displays the index images, in which the still images using the “I” pictures 312I are appropriately reduced, sequentially arranging lengthwise or widthwise (S7).

Next, the CPU 114 adds the GOP interval to the counter n for shifting the counter n to the amount of the GOP interval (S8).

Subsequently, the CPU 114 determines whether or not a termination condition is fulfilled, based on the fact that the counter n becomes equal to or larger than the total number of GOPs (S9). The CPU 114 terminates the reproduction control process of the video when the termination condition is fulfilled, but when otherwise, the CPU 114 goes back process to S6, and repeats the operations from S6 to S9. By repeating the operations from S6 to S9, the CPU 114 detects the GOP at GOP intervals and extracts the “I” picture 312I. Note that in S10, a first image of the moving image data is displayed. In this case, the shot video is reproduced without displaying the index images.

By doing as described above, the GOPs are detected at GOP intervals, the “I” pictures are extracted from the detected GOPs and the index images using the “I” pictures are displayed on the LCD 109 in a state of being sequentially arranged lengthwise or widthwise.

When reproducing the moving image data, the user selects a desired index image while looking at the whole index image displayed on the LCD 109 (individual index images displayed on the LCD 109 are collectively called as the index image), and selects the index image by operating the operation unit 115 as an image selection device. Accordingly, the video is reproduced from a corresponding position of the selected index image (the GOP corresponding to the selected index image).

As described above, since the camera apparatus 100 displays the plurality of index images before reproducing the video, the user can grasp the contents of the video by looking at the index images without reproducing the video expressly. In other words, the plurality of index images are temporarily used for checking the contents of the shot video to be reproduced, and the generation and display of the index images and the reproduction of the shot video are organically associated with each other.

Further, when the user selects the desired index image, the video is reproduced from the GOP corresponding to the selected index image, which results in saving a lot of time searching for the position of the image to be reproduced.

In the camera apparatus 100, the index images of the shot video are displayed only by selecting the index reproduction. Therefore it is possible to reproduce the shot video after checking the contents without generating and saving the index images expressly, which is very convenient.

Further, when the camera apparatus 100 generates the index images before reproducing the video, the generated index images are displayed on the LCD 109, but not recorded in a memory card or the like. Therefore, the camera apparatus 100 does not need the memory card or the like for saving the index images.

It should be noted that the above-described camera apparatus 100 is provided with the HDD 105 as an external memory apparatus capable of writing/reading data based on the random access, however, other than the HDD 105, a DVD drive recoding data into a DVD (Digital Versatile Disk) may be provided. Then, it goes well when the moving image data is memorized in a rewritable memory media such as DVD-RW, DVD-RAM and the like by the DVD drive.

The description in the above is to describe the embodiments of the invention and, in no case, limits the apparatus and method of the invention, so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising
a reproduction control unit reproducing a shot video after a plurality of index images using “I” frames extracted at predetermined intervals from moving image data for reproducing the shot video are generated and displayed, when reproducing the shot video.

2. A camera apparatus comprising:
a reproduction device reproducing a shot video;
an extraction unit extracting “I” frames at predetermined intervals from moving image data necessary for said reproduction device to reproduce the shot video;
an index image generating unit generating a plurality of index images using the “I” frames extracted by said extraction unit; and
a reproduction control unit reproducing the shot video after the index images generated by said index image generating unit are displayed, when said reproduction device reproduces the shot video.

3. The camera apparatus according to claim 1, further comprising an image selection device selecting the index image, and
wherein said reproduction control unit controls in such a manner that the shot video is reproduced from a position corresponding to the index image selected by said image selection device among the moving image data.

4. The camera apparatus according to claim 2, further comprising an image selection device selecting the index image, and
wherein said reproduction control unit controls in such a manner that the shot video is reproduced from a position corresponding to the index image selected by said image selection device among the moving image data.

5. The camera apparatus according to claim 1, further comprising a mode selection device to select either an index reproduction mode reproducing the shot video after displaying the index images or a normal reproduction mode reproducing the shot video without displaying the index images.

6. The camera apparatus according to claim 2, further comprising a mode selection device to select either an index reproduction mode reproducing the shot video after displaying the index images or a normal reproduction mode reproducing the shot video without displaying the index images.

7. The camera apparatus according to claim 2, further comprising a detection unit to detect a GOP at predetermined intervals from the GOPs constituting the moving image data, and
wherein said extraction unit is structured to extract the “I” frames included in the GOP detected by said detection unit.

8. A reproduction control method in a camera apparatus provided with a reproduction device reproducing a shot video,
wherein the shot video is reproduced after a plurality of index images using “I” frames extracted at predetermined intervals from moving image data for reproducing the shot video are generated and displayed, when the reproduction device reproduces the shot video.
